(19) United States
(12) Patent Application Publication
(10) Pub. No.: US 2025/0385279 A1
(43) Pub. Date: Dec. 18, 2025

(54) DIFFUSION LAYER FOR AN ELECTROCHEMICAL CELL, ELECTROCHEMICAL CELL, AND METHOD FOR PRODUCING A DIFFUSION LAYER

(71) Applicant: Robert Bosch GmbH, Stuttgart (DE)

(72) Inventors: Andreas Gehrold, Bamberg (DE); David Thomann, Bamberg (DE)

(21) Appl. No.: 18/706,931

(22) PCT Filed: Oct. 31, 2022
(86) PCT No.: PCT/EP2022/080321

§ 371 Date: May 2, 2024

(30) Foreign Application Priority Data
Nov. 3, 2021 (DE) 10 2021 212 382.1

(51) Int. Cl. H01M 8/0276; B23K 26/03; B23K 26/082; B23K 26/38; B23K 26/402; B23K 101/36; B23K 103/00; H01M 8/0234; H01M 8/0284; H01M 8/0286; H01M 8/10; H01M 8/1004

(52) U.S. Cl. CPC H01M 8/0276; B23K 26/032; B23K 26/38; B23K 26/402; H01M 8/0234; H01M 8/0284; H01M 8/0286; H01M 8/1004; B23K 26/082; B23K 2101/36; B23K 2103/50; H01M 2008/1095

(57) ABSTRACT

A fiber-based diffusion layer (5, 6) for an electrochemical cell (100), wherein the diffusion layer (5, 6) has a cut edge (55). The diffusion layer (5, 6) has, adjacent to the cut edge (55), an adhesive strip (60).

### BACKGROUND

The invention relates to a diffusion layer for an electrochemical cell, in particular for a fuel cell, an electrochemical cell and a method for producing a diffusion layer.

Hydrogen-based fuel cells are regarded as the basis for a mobility concept of the future, as they essentially only emit water and enable fast refueling times. Fuel cells are electrochemical energy converters or electrochemical cells, wherein a number of such fuel cells are interconnected to form a fuel cell stack in order to provide a correspondingly high total voltage or total power. The reactants hydrogen (H2) and oxygen (O2) are converted into electrical energy, water (H2O) and heat.

For example, PEM (proton-exchange-membrane) fuel cells can be operated with the air supplied to the cathode of the fuel cell, with oxygen as the oxidizing agent, and the hydrogen supplied to the anode of the fuel cell as fuel in an electrocatalytic electrode process in order to provide electrical energy with a high degree of efficiency. Fuel cell systems with PEM fuel cells are already on the market in initial series applications and have great potential to play a significant role in the energy and transportation transition; the same applies to other electrochemical cells such as electrolysis cells and battery cells.

A fuel cell typically contains a membrane electrode assembly (MEA) formed by a catalyst-coated membrane arranged between a pair of diffusion layers. The catalyst-coated membrane itself usually has an electrolyte membrane arranged between a pair of catalyst layers or electrode layers. One such version of an electrochemical cell designed as a fuel cell is known, for example, from DE 10 2018 203 828 A1.

### SUMMARY

The task of the present invention is to minimize the risk of fiber ends standing up or sticking out for a fiber-based diffusion layer. Protruding fibers can damage the membrane and cause unwanted and damaging short circuits in the electrochemical cell.

The fiber-based diffusion layer comprises a cut edge for this purpose. The diffusion layer has an adhesive strip adjacent to the cut edge.

The fiber structures of the diffusion layer are usually made of carbon and are therefore brittle and can break during the production of the diffusion layer or during the assembly process of the electrochemical cell or a cell stack. The resulting fiber ends from the diffusion layer can protrude from it and consequently pierce the very thin (e.g. <20 μm) and mechanically sensitive catalyst-coated membrane. This leads to irreparable damage to the electrochemical cell and to failure of the electrochemical cell in a very short time. It is therefore important to manufacture the diffusion layer that is inserted into the electrochemical cell in such a way that as few fiber ends as possible protrude.

The adhesive strip is an adhesive applied in the form of a flat or strip. The adhesive can only cover the top surface of the diffusion layer or penetrate into the open-pored fiber structure.

The adhesive strip is preferably formed around the circumference of the diffusion layer. The adhesive is therefore applied all the way around the edge of the diffusion layer, so that potentially protruding fibers are prevented over the entire circumference.

In alternative embodiments, the adhesive can also be applied only to individual sides of the diffusion layer. This is particularly advantageous if the membrane cannot be damaged on the other sides, for example if one edge of the diffusion layer rests over a large area on a robust frame structure.

All adhesive materials are conceivable for the adhesive, as the adhesive strip is preferably arranged outside the active surface of the electrochemical cell so that the adhesive is not exposed to the harsh operating conditions in the active surface.

In particular, if the adhesive strip or adhesive is also used to subsequently fix the diffusion layer to a distributor plate or bipolar plate, a thermoplastic adhesive is advantageously used.

The adhesive strip can reach right up to the cut edge or be arranged at a distance from it. If it is arranged at a distance, no adhesive material is wasted and the adhesive strip does not have to be cut. If the adhesive strip reaches right up to the cut edge, the fibers are fixed particularly well at the cut edge.

The invention also comprises an electrochemical cell, in particular a fuel cell, with at least one, preferably two diffusion layers according to one of the above embodiments. The electrochemical cell further comprises a membrane-electrode assembly, wherein the diffusion layer and the membrane-electrode assembly are in contact with each other at least in an active surface of the electrochemical cell. Due to their electrical conductivity and gas permeability, the fiber-based diffusion layers described are particularly suitable for electrochemical cells. Preferably, one diffusion layer is arranged on the cathode side and one on the anode side of the membrane electrode assembly.

In advantageous embodiments, the membrane-electrode assembly has a membrane designed as a polymer electrolyte membrane. The polymer electrolyte membrane has many advantages, especially for electrochemical cells up to an operating temperature of 100° C., but can be susceptible to protruding fibers, which in the worst case can puncture the polymer electrolyte membrane and cause both an electrical and a gas short circuit in the electrochemical cell. This risk of damage is now reduced or even eliminated by fixing the fibers with the adhesive strip.

Furthermore, the invention also comprises manufacturing methods for a fiber-based diffusion layer according to the above embodiments. The method comprises the following steps:
application of an adhesive strip to the diffusion layer in the region of a later cut edge,
cutting the diffusion layer in the region of the adhesive strip.

Advantageously, the cutting of the diffusion layer is carried out as laser cutting. In contrast to cutting or punching with a knife, laser cutting allows each individual fiber of the carbon fiber mat or the fiber-based diffusion layer to be severed and melted, which prevents the formation of broken individual carbon fibers that could potentially pierce the membrane in the structure of the electrochemical cell. On the other hand, fewer or no dust-like particles are produced that can penetrate the diffusion layer in an undefined manner and impair the function of the electrochemical cell constructed with it.

Laser cutting is preferably carried out on a cutting system that has laser scanner optics. The laser scanner optics are linked to an image recognition system. The adhesive strip is arranged at a distance from the subsequent cut edge, wherein the distance is controlled by the image recognition. The laser scanner optics are therefore linked to the image recognition system, which recognizes the adhesive regions or the adhesive strip; this means that the cutting system can cut ideally close to the outside of the adhesive strip, as the laser beam can be flexibly directed for cutting. This makes it easy to compensate for positional inaccuracies resulting from the gluing step and web transport.

In advantageous embodiments of the method, the adhesive strip is arranged at a distance from the subsequent cut edge. As a result, no adhesive material is vaporized during the cutting process and the energy required for the cutting process is minimized. This design can preferably be used for an electrochemical cell in which the cut edge rests on the subgasket or the frame structure of the membrane electrode assembly.

It is particularly preferable to apply the adhesive strip using screen printing, inkjet printing or dispensing. These are cost-effective and closely tolerated methods for applying the adhesive.

Advantageously, the initial state of the diffusion layer is a rolled product. On the one hand, this is the most cost-effective initial state, and on the other hand, the rolled product can be used very well for the subsequent production steps by simply unrolling it.

For example, the starting material for the production of the diffusion layer can be a carbon fiber mat coated with PTFE and/or platinum and/or with a membrane and/or a mat for a microporous layer. Even if the diffusion layer has other components than just a structure-forming material, such as a carbon fleece, the cutting process with the laser device is advantageous in order to introduce as little energy as possible into the layer, which could change the distribution of the components within the structure-forming material, such as the fiber structure of the diffusion layers, to the detriment of the operation of the electrochemical cell. Another component can also be a microporous layer that is applied to the diffusion layer or the carbon fiber mat before cutting.

### BRIEF DESCRIPTION OF THE DRAWINGS

In the following, exemplary embodiments of the invention are explained in more detail with reference to the figures. The following is shown in the figures:

FIG. 1 a schematic diagram of a fuel cell known from the prior art, wherein only the essential regions are shown,

FIG. 2 a section of a membrane electrode assembly, wherein only the essential regions are shown,

FIG. 3 a section of another membrane electrode assembly, wherein only the essential regions are shown,

FIG. 4 a section of a fiber-based diffusion layer in plan view, wherein only the essential regions are shown,

FIG. 5 a top view of a fiber-based diffusion layer according to the invention, wherein only the essential regions are shown,

FIG. 6 a top view of another fiber-based diffusion layer according to the invention, wherein only the essential regions are shown,

FIG. 7 schematically shows a method for producing a fiber-based diffusion layer according to the invention.

### DETAILED DESCRIPTION

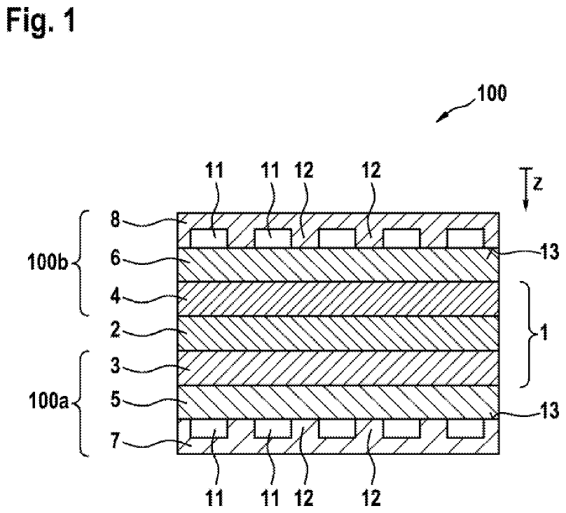

FIG. 1 schematically shows an electrochemical cell 100 known from the prior art in the form of a fuel cell, wherein only the essential regions are shown. The fuel cell 100 comprises a membrane 2, in particular a polymer electrolyte membrane. To one side of the membrane 2 a cathode space 100a is formed, to the other side an anode space 100b.

In the cathode space 100a, outwardly facing from the membrane 2—therefore in the normal direction or stacking direction z—an electrode layer 3, a diffusion layer 5, and a distributor plate 7 are arranged. An electrode layer 4, a diffusion layer 6, and a distributor plate 8 are in a similar manner arranged in the anode space 100b facing outwardly from the membrane 2. The membrane 2 and the two electrode layers 3, 4 form a membrane electrode assembly 1. Optionally, the two diffusion layers 5, 6 can also be part of the membrane electrode assembly 1. Optionally, one or both diffusion layers 5, 6 can also be eliminated, provided that the distributor plates 7, 8 can provide sufficiently homogeneous gas feeds.

The distributor plates 7, 8 have channels 11 for the gas supply—for example air in the cathode space 100a and hydrogen in the anode space 100b—to the gas diffusion layers 5, 6. The diffusion layers 5, 6 typically consist of a carbon fiber fleece on the channel side—i.e., towards the distributor plates 7, 8—and a microporous particle layer on the electrode side—i.e., towards the electrode layers 3, 4.

The distributor plates 7, 8 comprise the channels 11 and thus implicitly also connecting portions 12 adjacent to the channels 11. The undersides of these connecting portions 12 thus form a contact surface 13 of the respective distributor plate 7, 8 to the underlying diffusion layer 5, 6.

Usually, the cathode-side distributor plate 7 of an electrochemical cell 100 and the anode-side distributor plate 8 of the adjacent electrochemical cell are firmly connected, for example by welded joints, and thus combined to form a bipolar plate.

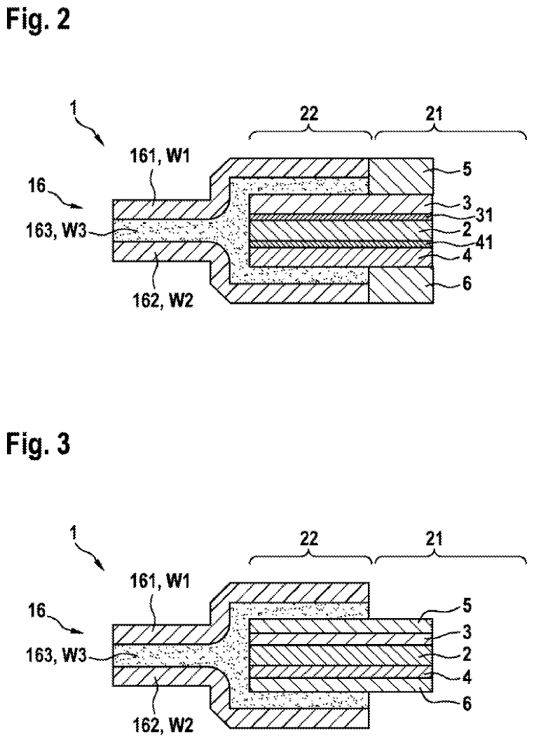

FIG. 2 shows a vertical section of the membrane electrode assembly 1 of an electrochemical cell 100, in particular a fuel cell, wherein only the essential regions are shown. The membrane electrode assembly 1 has the membrane 2, for example a polymer electrolyte membrane (PEM), and the two porous electrode layers 3 and 4, each with a catalyst layer, wherein the electrode layers 3 and 4 are each arranged on one side or surface of the membrane 2. The electrochemical cell 100 further comprises the two gas diffusion layers 5 and 6 which, depending on the embodiment, can also belong to the membrane electrode assembly 1.

The membrane electrode assembly 1 is circumferentially surrounded by the frame structure 16, which in the present context is also referred to as a subgasket. The frame structure 16 is used to provide stiffness and tightness to the membrane electrode assembly 1 and is a non-active region of the electrochemical cell 100.

The frame structure 16 is in particular U-shaped or Y-shaped in section, wherein a first leg of the U-shaped frame section is formed by a first foil 161 made of a first material W1 and a second leg of the U-shaped frame section is formed by a second foil 162 made of a second material W2. In addition, the first film 161 and the second film 162 are bonded together by means of an adhesive 163 made of a third material W3. The first material W1 and the second material W2 are often identical and made of a thermoplastic polymer, e.g., PEN (polyethylene naphthalate).

The two diffusion layers 5 and 6 contact the membrane electrode assembly 1, or more precisely the respective electrode layer 3, 4, via an active surface 21. The electrode layers 3, 4 have a catalyst paste 31, 41 in which catalysts, usually catalyst particles, are embedded.

If the electrode layers 3, 4 are covered by the frame structure 16, then it is a non-active edge region 22 of the membrane electrode assembly 1. In the non-active edge region 22, then no reaction fluids reach the electrode layers 3, 4 or catalytic pastes 31, 41 of the embedded catalysts. As a result, chemical reactions do not take place in the edge region 22, and the current density of the electrochemical cell 100 thus drops very sharply relative to the active surface 21, or is even zero. The diffusion layers 5, 6 overlap or rest on the frame structure 16 in the non-active edge region 22.

FIG. 3 shows a membrane electrode assembly 1 in an embodiment similar to FIG. 2. In the embodiment shown in FIG. 3, however, the two diffusion layers 5, 6 are surrounded by the frame structure 16 in the non-active edge region 22 and no longer overlap it. In the embodiment shown in FIG. 3, the diffusion layers 5, 6 are thus also in contact with the respective electrode layer 3, 4 in the non-active edge region 22.

If the diffusion layer 5, 6 has fibers 51, these fibers 51 can irreversibly damage the membrane-electrode assembly 1 and in particular the membrane 2. This type of damage can occur in particular if individual fibers 51 are no longer arranged in the plane of the fiber layer, but protrude from the layer plane.

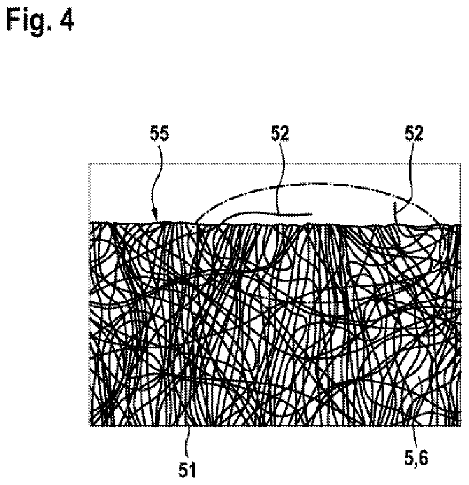

FIG. 4 shows a section of a fiber-based diffusion layer 5, 6 in plan view, which has one or more fibers 51. The diffusion layer 5, 6 is usually cut from a large-area rolled product and therefore has one or more cut edges 55. These cut edges 55 can lead to the formation of potentially harmful protruding fibers 52, two of which are shown as examples in FIG. 4.

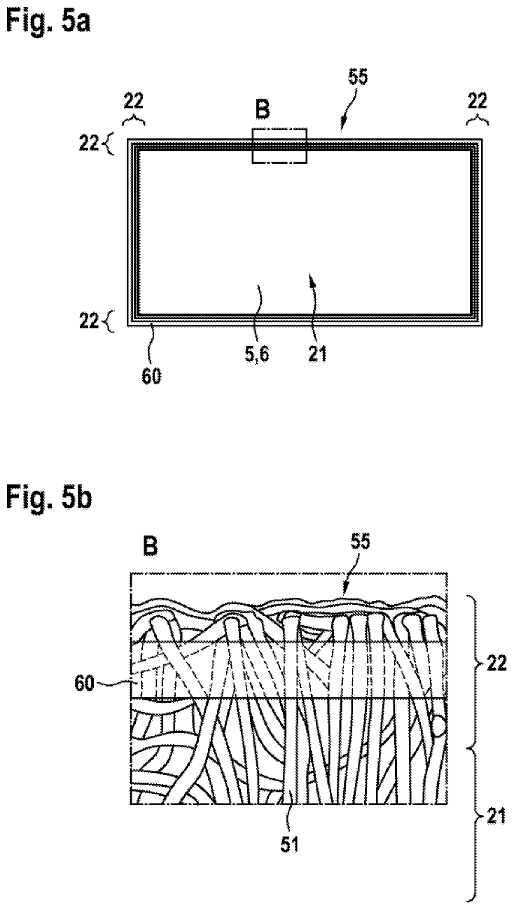

According to the invention, an adhesive strip 60 is now arranged at the cut edge 55. To this end, FIG. 5a shows a top view of a diffusion layer 5, 6 with an adhesive strip 60 arranged over the entire circumference, which is preferably located in the later non-active edge region 22 of the electrochemical cell 100.

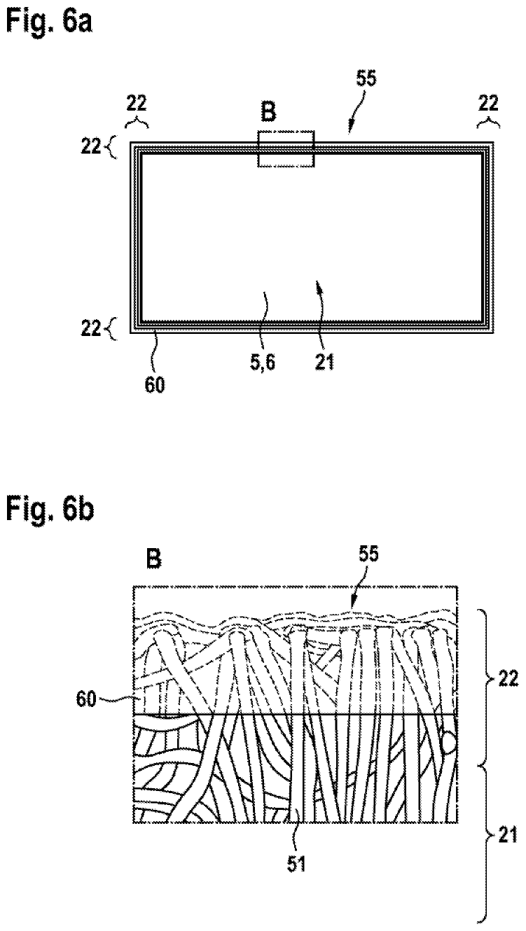

FIG. 5b shows the section B of FIG. 5a in an enlarged view, so that the shape of the fibers 51 of the diffusion layer 5, 6 can be clearly seen. The cut edge 55 is formed at the upper edge of the diffusion layer 5, 6. The approximately 20 μm wide adhesive strip 60 is arranged slightly below this-in the order of 10 μm. These geometries are only shown as examples. For example, the adhesive strip 60 can also be wider—preferably 20 μm to 100 μm—and the adhesive strip 60 can also extend directly up to the cut edge 55 or even originally beyond it; in the latter case, the adhesive strip 60 would be cut to size at the cut edge 55 in the cutting step equivalent to the diffusion layer 5, 6, see FIG. 6.

FIG. 6b shows schematically that the adhesive strip 60 protrudes beyond the cut edge 55; this is only for the sake of understanding. The adhesive strip 60 only protrudes beyond the later cut edge 55 in the initial state of the diffusion layer 5, 6 (preferably rolled product). In the cutting process step (preferably laser cutting), the adhesive strip 60 is cut to the target dimension together with the diffusion layer 5, 6 at the cut edge 55.

Preferably, therefore, the outermost edge, the adhesive strip 60, of the fiber-based diffusion layer 5, 6 is bonded in such a way that the fiber ends of the fibers 51 are fixed and thus a release of individual fibers 51 is prevented, so that there are no protruding fibers 52. The risk of damage-in particular to the membrane 2—due to fibers 51, 52 that reorient themselves unfavorably during further process steps and during operation is thus significantly reduced. This is particularly advantageous if the diffusion layer 5, 6 is arranged in an electrochemical cell 100 with a membrane 2 designed as a polymer electrolyte membrane.

The manufacturing process of such a diffusion layer 5, 6 ideally uses the process of laser cutting. In addition, the bonding of the fibers 51, i.e. the design of the adhesive strip 60, can be selected such that the function of fixing the diffusion layer 5, 6 on the membrane electrode assembly 1, preferably in the region of the frame structure 16, or on the distributor plate 7, 8 or the bipolar plate, which is carried out in a later process step, can also be taken over.

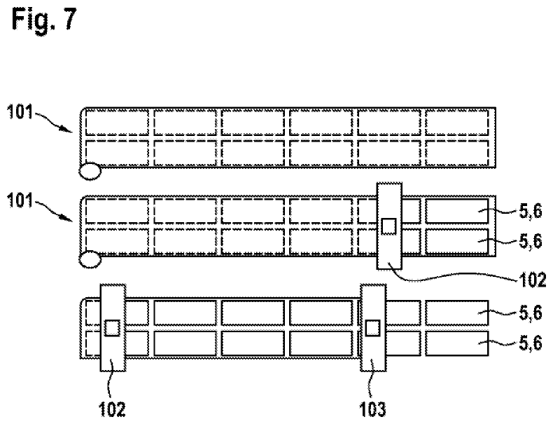

An advantageous method for producing a corresponding diffusion layer 5, 6 is outlined in FIG. 7. The initial state of the diffusion layer 5, 6 is a rolled product 101. This rolled product 101 is now to be used to produce rectangular pieces in the desired format for later use of the diffusion layer 5, 6—for example in a fuel cell. These pieces are usually larger in the plane than the active surface 21 of the membrane electrode assembly 1, so that they protrude on all four sides. There is therefore an outer region of the diffusion layer 5, 6—the non-active edge region 22—in which the gas distribution and electrical contacting functions do not have to be present. This region or parts of this region are provided with an adhesive layer or an adhesive strip 60 either only on the surface or in depth, in such a way that the fibers of the diffusion layer 5, 6 are fixed in the edge region and can therefore no longer change their position in an uncontrolled manner.

Ideally, a thermoplastic is used for bonding the fibers by an adhesive system 102, which can preferably also serve as an adhesive to the frame structure 16 in the assembly process of the membrane electrode assembly 1. After the adhesive strip 60 has been applied to the diffusion layer 5, 6, it is cut to the required size on a cutting system 103.

This results, for example, in the following advantageous manufacturing process for the diffusion layer 5,6:
1) The fiber-based diffusion layer 5,6 is unrolled as rolled product 101.
2) The adhesive strip 60 is applied to the adhesive system 102 so that the fibers 51 of the diffusion layer 5, 6 are fixed in this region. The adhesive strip 60 can only cover the top surface or penetrate the open-pored fiber structure. The adhesive can be applied using screen printing, inkjet printing or dispensing, for example. The adhesive can be applied to the entire diffusion layer 5, 6 or only to individual sides. The adhesive can be made from any adhesive material, as it is located outside the active region of the fuel cell and is therefore not exposed to the harsh operating conditions there.
3) The rolled product 101 with applied adhesive strip 60 is fed on and cut to the target size on a further system, the cutting system 103. Cutting processes such as water jet cutting, roll knife cutting and roll punching are conceivable for this purpose. Ideally, however, laser cutting is used. This is particularly advantageous if the laser scanner optics are linked to an image recognition system that recognizes the adhesive regions/the adhesive strip 60 and can therefore be cut ideally close outside the position of the adhesive strip 60, as the laser beam can be flexibly directed. This means that positional inaccuracies resulting from the application of the adhesive strip 60 and web transport can be easily compensated for.

1. A fiber-based diffusion layer (5, 6) for an electrochemical cell (100), wherein the diffusion layer (5, 6) has a cut edge (55), and wherein the diffusion layer (5, 6) has, adjacent to the cut edge (55), an adhesive strip (60).

2. The diffusion layer (5, 6) according to claim 1, wherein in that the cut edge (55) and the adhesive strip (60) are formed circumferentially around a circumference of the diffusion layer (5, 6).

3. The diffusion layer (5, 6) according to claim 1, wherein the adhesive strip (60) is configured to penetrate into a fiber structure of the diffusion layer (5, 6).

4. The diffusion layer (5, 6) according to claim 1, wherein the adhesive strip (60) is formed from a thermoplastic.

5. The diffusion layer (5, 6) according to claim 1, wherein the adhesive strip (60) extends up to the cut edge (55).

6. The diffusion layer (5, 6) according to claim 1, wherein the adhesive strip (60) is arranged at a distance from the cut edge (55).

7. An electrochemical cell (100) having a diffusion layer (5, 6) according to claim 1 and a membrane-electrode assembly (1), wherein the diffusion layer (5, 6) and the membrane-electrode assembly (1) are in contact with one another at least in an active surface (21) of the electrochemical cell (100).

8. The electrochemical cell (100) according to claim 7, wherein the membrane-electrode assembly (1) comprises a membrane (2) configured as a polymer electrolyte membrane.

9. A method for producing a fiber-based diffusion layer (5, 6) according to claim 1 comprising the steps of:
applying an adhesive strip (60) to the diffusion layer (5, 6) in a region of a later cut edge (55)
cutting the diffusion layer (5, 6) in the region of the adhesive strip (60).

10. The method according to claim 9, wherein the cutting of the diffusion layer (5, 6) is carried out as laser cutting.

11. The method according to claim 10, wherein the laser cutting is performed on a cutting system (103), wherein the cutting system (103) comprises laser scanner optics, wherein the laser scanner optics is linked to an image recognition, wherein the adhesive strip (60) is arranged at a distance from the later cut edge (55), wherein the spacing is controlled by the image recognition.

12. The method according to claim 9, wherein the adhesive strip (60) is arranged at a distance from the later cut edge (55).

13. The method according to claim 9, wherein the adhesive strip (60) is applied by screen printing, ink jet printing or dispensing.

14. The method according to claim 9, wherein an initial state of the diffusion layer (5, 6) is a rolled product (101).

15. The method according to claim 9, wherein the fiber-based diffusion layer (5, 6) is for an electrochemical cell (100).
